(19) United States
(12) Patent Application Publication
(10) Pub. No.: US 2002/0181049 A1
(43) Pub. Date: Dec. 5, 2002

(54) Optical heads for optical microphone/sensors

(76) Inventors: Alexander Paritsky, Modi'in (IL); Alexander Kots, Ashdod (IL)

Correspondence Address: Antonhy Castorina, G E Ehrlich 1995, Suite 207, 2001 Jefferson Davis Highway, Arlington, VA, 22202, US

(21) Appl. No.: 10/149,111

(22) PCT Filed: Oct. 15, 2001
(86) PCT No.: PCT/IL01/00953

(30) Foreign Application Priority Data
Oct. 16, 2000 (IL) 139065

(51) Int. Cl. H04B 10/02; H04R 25/00

(52) U.S. Cl. 359/150; 381/172

(57) ABSTRACT

The invention provides a head for an optical microphone/sensor, including two spaced-apart, integrally interconnected, juxtaposed lightguides made of transparent, moldable material; a first of the lightguides including a light-admitting end, an intermediate section and a light-transmitting end having a light-transmitting face, and a second of the lightguides including a light-receiving end having a light-receiving face, an intermediate section and a light-outputting end; the edges of the light-transmitting end and light-receiving end being disposed in close proximity to, or at least indirectly contacting, each other so as to optimally transmit light towards a membrane and receive light reflected from the membrane.

### FIELD OF THE INVENTION

The present invention relates to optical microphone/sensors, and more particularly, to an optical head for microphone/sensors.

### BACKGROUND OF THE INVENTION

Several different types of optical microphone/sensors are known, one of which utilizes optical fibers. These microphones, while being of high quality, are expensive, due to the relatively high costs of the optical fibers and of their technological processing.

Radio frequency interference (RFI) is a major problem in cellular telephones or like apparatus when, for example, the microphone is distant from the telephone apparatus and the connection lines between the microphone and apparatus are relatively long, e.g., several centimeters. In such a case, the RFI becomes so strong that the use of the distantly located microphone is impossible. This phenomenon is typical of electrical microphones.

A problem in fiber optics microphones is the relatively high cost of their production, which of necessity includes the requirement to polish different surfaces of the lightguides at different angles, and also involves other very complex and difficult processes regarding the exact assembly of both optical fibers.

### DISCLOSURE OF THE INVENTION

It is an object of the present invention to provide a low cost production process for an optical head and a microphone/sensor incorporating such a head.

The invention therefore provides a head for an optical microphone/sensor, comprising two spaced-apart, integrally interconnected, juxtaposed lightguides made of transparent, moldable material; a first of said lightguides including a light-admitting end, an intermediate section and a light-transmitting end having a light-transmitting face; a second of said lightguides including a light-receiving end having a light-receiving face, an intermediate section and a light-outputting end; the edges of said light-transmitting end and light-receiving end being disposed in close proximity to, or at least indirectly contacting, each other so as to optimally transmit light towards a membrane and receive light reflected from said membrane.

### BRIEF DESCRIPTION OF THE DRAWINGS

The invention will now be described in connection with certain preferred embodiments with reference to the following illustrative figures so that it may be more fully understood.

With specific reference now to the figures in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a side cross-sectional view of an optical microphone/sensor head according to the present invention, after molding and before assembly;

FIG. 2 is a top view of the optical head of FIG. 1 after molding;

FIG. 3 is a cross-sectional view of the lightguides along line A-A in FIG. 1, and

FIG. 4 is a cross-sectional view of an optical microphone/sensor according to the present invention, after assembly.

### DETAILED DESCRIPTION

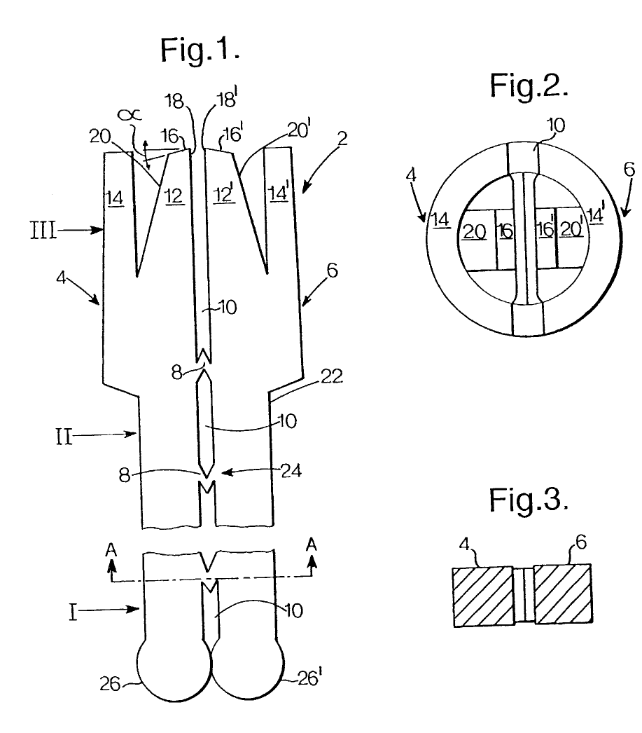

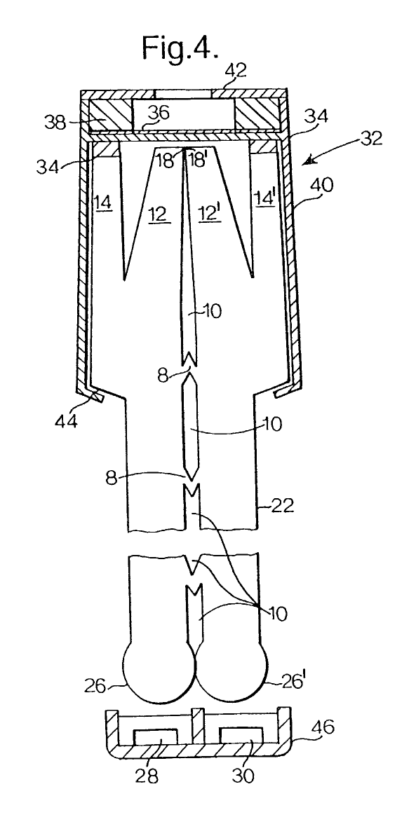

FIGS. 1 and 2 illustrate a lightguide head 2 for an optical microphone/sensor according to the present invention. Head 2 includes interconnected lightguides 4 and 6. The head 2 has three major sections: a first input/output section I, a lightguide section II and a second input/output section III. Both lightguides 4 and 6 are molded simultaneously as a joint pair with integral joining bridges 8 between them. Joining bridges 8 mechanically connect the two lightguides and separate them by a small gap 10 of e.g., several millimeters, thus ensuring stable light propagation and correct positioning of both lightguides. Section III of optical head 2 comprises split lightguide end portions 12, 12′ and 14, 14′, possessing a specific geometry: the top faces 16, 16′ of lightguides 4, 6 are molded in such a way that they are cut off at a small angle α relative to the axes of the lightguides, so that upon joining, the top edges 18, 18′ of portions 12, 12′ and the top faces 16, 16′ will be disposed substantially perpendicular to the axis of the gap 10 between lightguides 4, 6. The upper side surfaces 20, 20′ of end portions 12, 12′ are molded in such a way that they extend at an angle of about 15° to the axes of the lightguides. End portions 14, 14′ are arc-shaped (FIG. 2) and are utilized for assembling the optical microphone, as shown in FIG. 4.

The lightguides 4, 6 are made of transparent material and may have a square (FIG. 3), circular or elliptical cross-section. To prevent light leakage from the surfaces of the lightguides during operation, their surfaces are advantageously coated with a coating 22 of an opaque material. A preferred material for such a coating is aluminum; however, other materials may just as well be used. Coating 22 may be applied by spraying, electrodeposition, electrochemical plating, or any other process.

Since the joining bridges 8 are integrally formed during the process of molding the lightguides 4, 6 with the same transparent material as the lightguides, in order to prevent the leakage of light from one lightguide to the other through the bridges 8, the bridges may advantageously be made in the form of light traps 24, preventing the direct propagation of light from one guide to the other.

Input/output section I of head 2 is advantageously formed with half-spherical surfaces 26, 26′, which act as lenses for improved optical interaction with light source 28 and photodetector 30 (FIG. 4).

FIG. 4 illustrates the optical microphone/sensor of the invention after assembly. In addition to lightguide 2, microphone/sensor 32 includes a spacer 34 supported on portions 14, 14′ of the lightguide head to provide the required preset distance between the upper end of optical head 2 and a membrane 36 affixed on ring 38. The latter components are assembled and joined by a housing 40 having an opening 42 optionally affixed onto the shoulder means 44 made in section III of head 2. During assembly, the upper edges 18, 18′ of portions 12, 12′ of the lightguides are brought into contact with each other by the pressure applied to them by the walls of the housing, thus diminishing the gap between them to zero. The light source 28 and photodetector 30 are embedded, or otherwise encased, in a housing 46 and placed in the electrical portion of the microphone/sensor.

The production of the entire optical microphone/sensor consists of three main operations: (1) molding of two lightguides 4, 6, connected to one another by bridges, the lightguides being placed in precisely pre-calculated disposition with relation to one another and with the faces of the lightguides from which light is emitted and received being at precisely pre-calculated angles; (2) coating surfaces of said lightguides with an opaque material, thus forming an optical lightguide head, and (3) assembling the lightguide head into an optical microphone/sensor, by attaching a housing 40 furnished with a membrane 36 to the head.

After assembly, the optical microphone/sensor is ready to work when installed adjacent to a light source and a light detector. The operation of the microphone/sensor is as follows: A light beam from light source 28 is transmitted through spherical surface 26 into lightguide 4, and via same to face 16 of the optical head 2. The light beam is emitted from surface 16, impinges on membrane 36, and is reflected by the membrane into face 16′ and through light guide 6, until it reaches spherical surface 26′ and exits toward detector 30. Acoustical pressure changes the position of membrane 36 near the upper part of lightguide head 2, causing the intensity modulation of the light that is reflected from lightguide 4 and enters into lightguide 6. As a result, the electrical output signal of photodetector 30 is correspondingly changed, and the acoustical signal is registered.

It will be evident to those skilled in the art that the invention is not limited to the details of the foregoing illustrated embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

1. A head for an optical microphone/sensor, comprising:
two spaced-apart, integrally interconnected, juxtaposed lightguides made of transparent, moldable material;
a first of said lightguides including a light-admitting end, an intermediate section and a light-transmitting end having a light-transmitting face;
a second of said lightguides including a light-receiving end having a light-receiving face, an intermediate section and a light-outputting end;
the edges of said light-transmitting end and light-receiving end being disposed in close proximity to, or at least indirectly contacting, each other so as to optimally transmit light towards a membrane and receive light reflected from said membrane.

2. The head as claimed in claim 1, wherein each of said light-transmitting end and said light-receiving end are split into a first part and a second part, said first parts including said light-transmitting face or light-receiving face and having surfaces sloping away from each other towards said intermediate section.

3. The head as claimed in claim 1, wherein said lightguides are interconnected by means of joining bridges configured to prevent light from passing from one lightguide to the other.

4. The head as claimed in claim 1, wherein at least portions of the surfaces of said lightguides are coated with opaque material.

5. The head as claimed in claim 1, wherein said light-admitting end and said light-outputting end are configured as a lens.

6. The head as claimed in claim 1, further comprising means for attaching a housing thereto.

7. The head as claimed in claim 6, wherein said means are shoulder means integrally formed at the outside surface of said head.

8. The head as claimed in claim 1. wherein said light-transmitting end of said first ligthtguide and said light-receiving end of said second lightguide have substantially rectangular cross-sections.

9. The head as claimed in claim 1, wherein the second parts or said light-transmitting end and said light-receiving end are shaped as curved walls, forming a cylindrical configuration.

10. The head as claimed in claim 1, further comprising a membrane affixed in spaced-apart relationship to said faces.

11. The head as claimed in claim 10, wherein said membrane is supported on said second part.

12. The head as claimed in claim 1, further comprising a light source disposed adjacent to said light-admitting end and a light detector disposed adjacent to said light-outputting end.
